(19) United States
(12) Patent Application Publication
(10) Pub. No.: US 2004/0094357 A1
(43) Pub. Date: May 20, 2004

(54) Method for manufacturing diaphragm for loudspeaker, diaphragm for loudspeaker made thereby, and loudspeaker using the same

(76) Inventors: Hitoshi Sato, Mie (JP); Sinya Mizone, Mie (JP); Kiyoshi Ikeda, Mie (JP); Hiroko Yamazaki, Mie (JP)

Correspondence Address: RATNERPRESTIA, P O BOX 980, VALLEY FORGE, PA, 19482-0980, US

(21) Appl. No.: 10/613,456

(22) Filed: Jul. 3, 2003

Related U.S. Application Data
(62) Division of application No. 09/485,037, filed on May 22, 2000, now Pat. No. 6,627,140.
Application No. 09/485,037 is a 371 of international application No. PCT/JP99/03140, filed on Jun. 11, 1999.

(30) Foreign Application Priority Data
Jun. 12, 1998 (JP) 10-164892

(51) Int. Cl. H05H 1/00

(52) U.S. Cl. 181/157; 264/446; 264/483; 264/129; 427/536

(57) ABSTRACT

A method for manufacturing a speaker diaphragm used for a range of audio equipment, a speaker diaphragm made using this manufacturing method, and a speaker employing such diaphragm. This manufacturing method for a speaker diaphragm offers good productivity, preventing deviation in wettability and heat deformation of speaker diaphragms in plasma treatment, and also offers a speaker with good input power durability. A meshed etching tunnel (2) made of aluminum is disposed inside a cylindrical quartz reactive chamber (1), and speaker diaphragms (4) are aligned inside the tunnel at a certain interval. Opposing electrodes (5) are disposed outside the reactive chamber (1). Plasma is applied at low temperature to prevent heat deformation. Uniform wettability is also assured by the use of the meshed etching tunnel (2), achieving high productivity. Uniform wettability further stabilizes bonding and improves bonding strength of the speaker diaphragm (4) onto the voice coil (18) and etching (19a), offering a speaker with improved input power durability.

### FIELD OF THE INVENTION

The present invention relates to the field of methods for manufacturing loudspeaker diaphragms employed in a range of audio equipment, loudspeaker diaphragms made using such methods, and loudspeakers employing such diaphragms.

### BACKGROUND OF THE INVENTION

The configuration of a conventional loudspeaker is described with reference to its sectional view in FIG. 7. A magnetic circuit 15 includes a magnet 15a, lower plate 15b, and upper plate 15c.

A frame 16 is bonded to the magnetic circuit 15. A damper 17 holds a voice coil 18. The outer circumference of the damper 17 is bonded to the frame 16, and its inner circumference is bonded to the voice coil 18 whose coil 18a is embedded in the magnetic gap 15d of the magnetic circuit 15.

A loudspeaker diaphragm 19 is bonded to the frame 16 via an edge 19a bonded to its outer circumference, and the inner circumference of the loudspeaker diaphragm 19 is bonded to the voice coil 18. This loudspeaker diaphragm 19 is generally made mainly of paper or thin resin plates, which is selected depending on the need for weather resistance and required acoustic characteristics. method for manufacturing a typical loudspeaker diaphragm 19 made of resin, more specifically a polyolefin polyethylene loudspeaker diaphragm, is described next.

A loudspeaker diaphragm made of polyethylene, which is a type of polyolefin system, has low material density which gives the loudspeaker diaphragm a low mass. It also has relatively large internal loss with respect to mechanical vibration, which improves the frequency characteristic of the loudspeaker. Accordingly, polyethylene loudspeaker diaphragms are commonly used in loudspeakers. However, a polyethylene loudspeaker diaphragm has low adhesivity, making it essential to activate the surface of the loudspeaker diaphragm to improve bonding strength.

Common conventional methods for activating the surface of the loudspeaker diaphragm 19 include the application of primer after corona discharge, and surface treatment of the loudspeaker diaphragm 19 by the gas plasma treatment method using parallel flat electrodes 20 and 21 as shown in FIGS. 8 and 9.

However, the conventional surface activating technology for treating the surface of the loudspeaker diaphragm has the following disadvantages.

As for the method involving surface activation by corona discharge and primer application, a large processing apparatus is required because only the areas close to electrodes 20 and 21 are activated if the electrodes are small, causing a deviation in wettability of the loudspeaker diaphragm 19. In addition, this treatment takes about 30 seconds for one face of the loudspeaker diaphragm 19. The workpiece then needs to be flipped or the loudspeaker diaphragm 19 needs to be flipped to apply treatment to the other face, requiring more than one minute for each piece and seriously degrading productivity.

Furthermore, it has another problem that the loudspeaker diaphragm may deform during corona discharge due to high temperatures above 80° C. in the reactive chamber.

The method using the parallel flat electrode 20 in FIG. 8 also creates the risk of heat deformation and low productivity of the loudspeaker diaphragm 19. The method using the parallel flat electrode 21 in FIG. 9 may also cause low productivity. If more than one loudspeaker diaphragm 19 is handled at once to solve the problem of low productivity, it may still have the risk of heat deformation, and significant difference in wettability between the periphery and the center.

### SUMMARY OF THE INVENTION

A resin loudspeaker diaphragm made by injection molding or sheet forming by heating is disposed in a reactive chamber, and electrodes are provided outside of the reactive chamber. Plasma is applied to the loudspeaker diaphragm to activate the surface. Provision of electrodes outside the reactive chamber enables to keep the temperature of the reactive chamber below the heat deformation temperature of the loudspeaker diaphragm during plasma treatment. Accordingly, heat deformation of the loudspeaker diaphragm is preventable and defects caused by heat deformation can be suppressed.

### BRIEF DESCRIPTION OF THE DRAWINGS

FIG. 1 is a perspective view illustrating a method for manufacturing a loudspeaker diaphragm in an exemplary embodiment of the present invention for describing plasma treatment of the loudspeaker diaphragm.

FIG. 2 is a sectional view illustrating the loudspeaker diaphragm aligned in a quartz reactive chamber, which is a part of the exemplary embodiment of the present invention.

FIG. 3 is a temperature change graph during consecutive operation of the quartz reactive chamber in the exemplary embodiment of the present invention.

FIG. 4 is a comparison of durability of wettability in the exemplary embodiment of the present invention.

FIG. 5 is a sectional view illustrating the bonding state of the loudspeaker diaphragm and a voice coil.

FIG. 6 is a sectional view illustrating the bonding state of the loudspeaker diaphragm and an edge.

FIG. 7 is a side sectional view of a conventional loudspeaker.

FIG. 8 is a sectional view of a portion of a conventional loudspeaker illustrating plasma treatment for the loudspeaker diaphragm using parallel flat electrodes.

FIG. 9 is a sectional view of a portion of a conventional loudspeaker illustrating plasma treatment for the loudspeaker diaphragm in FIG. 8 using another type of parallel flat electrodes.

### DESCRIPTION OF THE PREFERRED EMBODIMENT

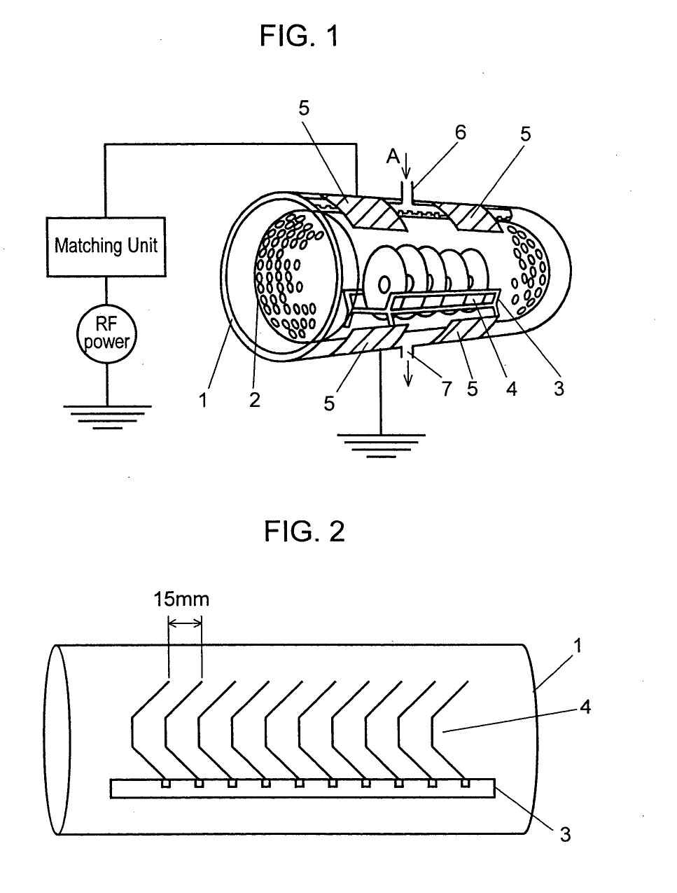

A method for manufacturing a loudspeaker diaphragm in an exemplary embodiment of the present invention is described with reference to FIGS. 1 to 6. The configuration of the loudspeaker itself is the same as that of the prior art, and thus its explanation is omitted here.

In FIGS. 1 to 6, a meshed cylindrical aluminum etching tunnel 2 is provided inside a cylindrical quartz reactive chamber 1. A loudspeaker diaphragm 4 (corresponding to the loudspeaker diaphragm 19 in the prior art) is held by a loudspeaker diaphragm holder 3 in the reactive chamber 1 in parallel with other loudspeaker diaphragms at approximately equal intervals. A gas inlet 6 is provided on the reactive chamber 1, and reactive gas A flows in from this gas inlet 6 through the etching tunnel 2 formed of meshed aluminum to the reactive chamber 1. Two pairs of electrodes 5 are provided facing each other on the outside face of the reactive chamber 1. A gas outlet 7 is also provided.

Details of the method for manufacturing the loudspeaker diaphragm 4 using the above reactive chamber 1 are described next. Ultra high polymer polyethylene resin called “LUBMER” (product name) manufactured by Mitsui Chemicals, Inc. is used for the loudspeaker diaphragm 4. This “LUBMER” is formed into the loudspeaker diaphragm 4 having a diameter of 16 cm by composite molding of injection or pressing, using an ultra high speed injection molding machine. The characteristics of this resin are shown in Table 1.

TABLE 1

| | | |
|---|---|---|
| Heat deformation temperature | 82 | ° C. |
| Melting point | 137 | ° C. |
| Water supply rate | 0.01> | % |
| Strength of tensile breakage point | 530 | kg/cm² |
| Elongation of breakage point | 7 | % |
| Bending strength | 18400 | kg/cm² |

It is apparent from Table 1 that this resin starts to deform at 82° C., and the loudspeaker diaphragm 4 is exposed to the danger of deformation at the temperature 80° C. or above in the reactive chamber 1.

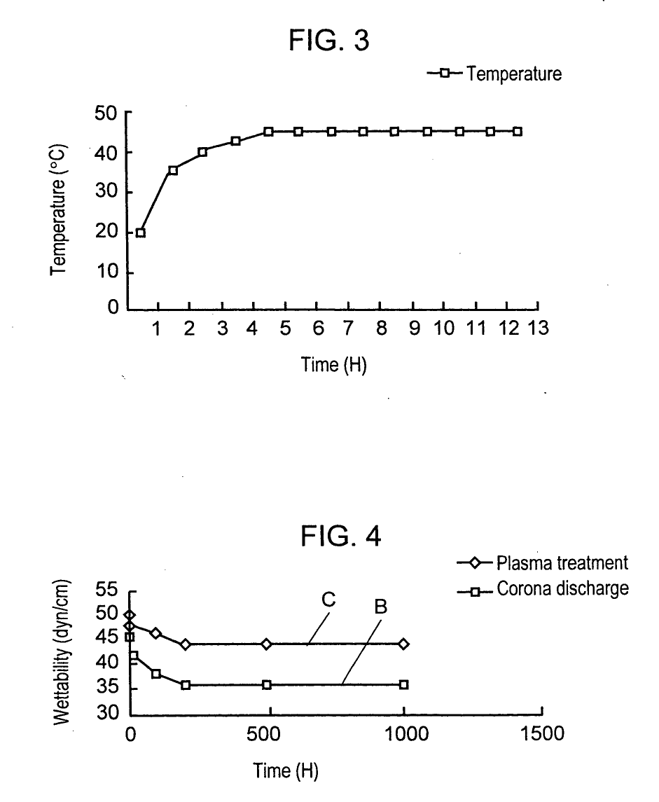

The size of the quartz reactive chamber 1 is 300 mm in diameter and 500 mm in length. As shown in FIG. 2, 30 loudspeaker diaphragms 4 of diameter 16 cm are aligned at 15 mm intervals. For the reactive gas A, oxygen gas is employed. To achieve a vacuum of 0.9 torr under high frequency output of 500 W, the vacuuming time is set to 1.5 minutes, plasma treatment time to 1 minute, and the return to normal pressure 1.5 minutes, which totals about 4 minutes per cycle. FIG. 3 shows the changes in temperature during consecutive operations under the above conditions. As shown in FIG. 3, the temperature inside the reactive chamber is stabilized at about 45° C. even after consecutive operation for 12 hours, and no loudspeaker diaphragm 4 was deformed.

The wettability of the loudspeaker diaphragm 4 obtained through the above process is 50 dyn/cm or above on any part of the loudspeaker diaphragm 4. This allows the assumption that plasma is applied uniformly by the use of the meshed etching tunnel 2.

For further improving the quality, isocyanate manufactured by Takeda Chemical Industries. Ltd., called “Takenate M402” (product name) is used as the primer. FIG. 4 shows the durability of its wettability.

It is apparent from FIG. 4 that the wettability B immediately after treatment in the conventional method of applying primer after corona discharge is relatively high at 46 dyn/cm. However, it degrades with time, falling to about 36 dyn/cm after 200 hours.

The exemplary embodiment in which the primer is applied after plasma treatment is shown as characteristic C in FIG. 4. It shows that the wettability immediately after treatment is a very high 50 dyn/cm, and the primer maintains a high wettability of 44 dyn/cm for considerable time, proving its stability.

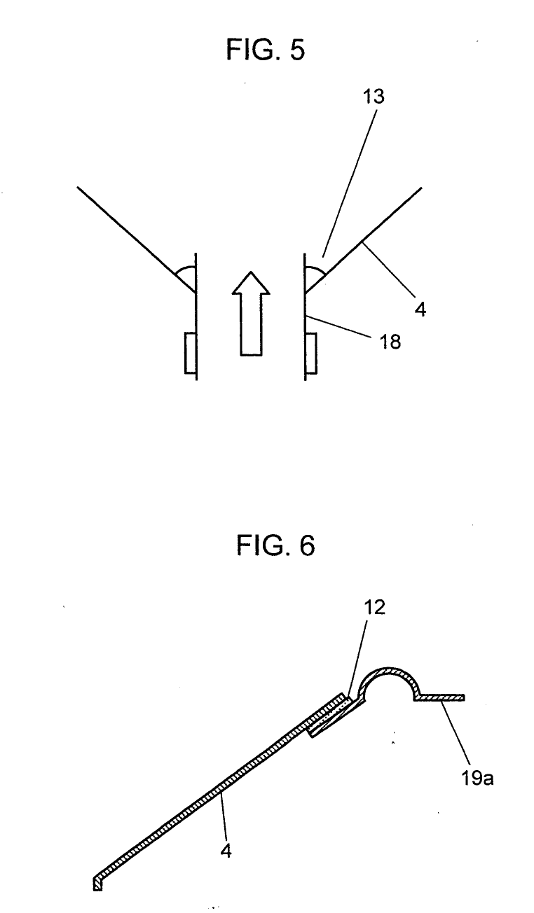

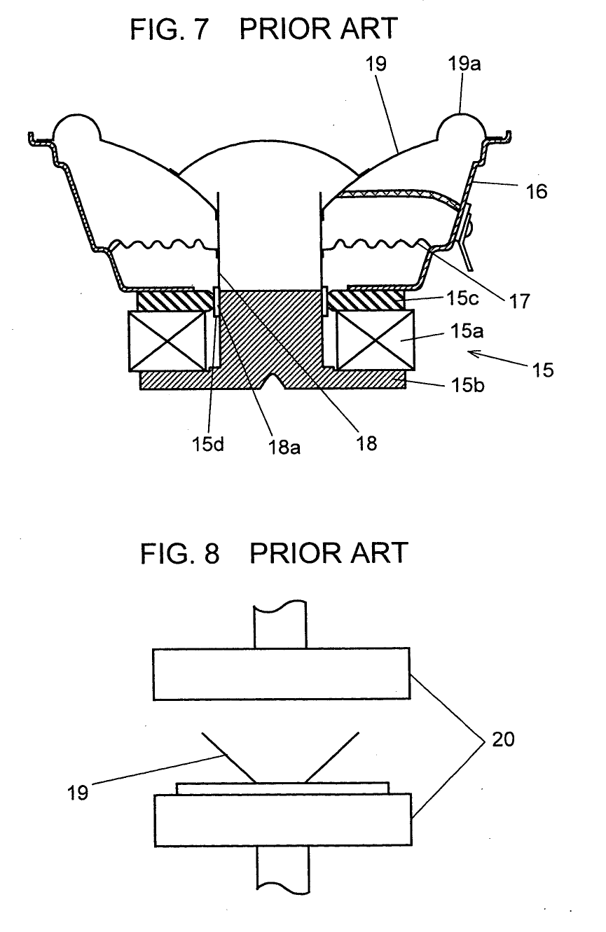

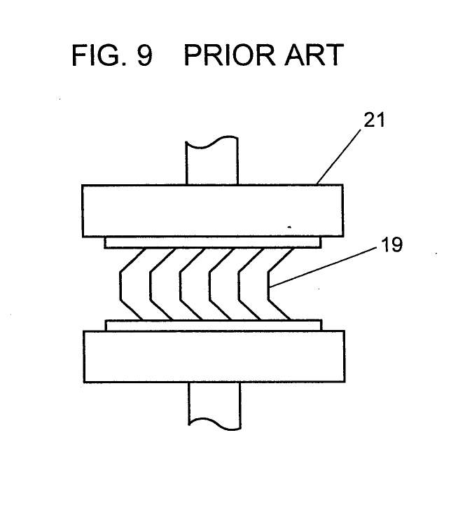

Next, as shown in FIGS. 5 and 6, the strength was compared between the loudspeaker diaphragm 4 to which the primer was applied after plasma treatment in this exemplary embodiment and the voice coil 18 and edge 19a were bonded using adhesives 12 and 13; and the conventional loudspeaker diaphragm to which the primer was applied after corona discharge and the voice coil and edge were bonded.

The voice coil 18 shown in FIG. 5 has a diameter of 32 mm. The adhesive 13 is a two-part reactive acrylic adhesive, and it is used for bonding the voice coil 18 onto the loudspeaker diaphragm 4. The bonding strength was measured by pulling the voice coil 18 in the direction indicated by the arrow.

The edge 19a shown in FIG. 6 is made of rubber, and it is bonded to the loudspeaker diaphragm 4 using the adhesive 12 which is butyl rubber solvent adhesive. The peeling strength was tested using a bonding area of 25 mm wide and 5 mm long.

A Ø16 cm loudspeaker was then made using the above Ø32 voice coil 18 and edge 19a, and the input power durability was tested. Table 2 shows the results of each test.

TABLE 2

| | plasma treatment | corona discharge |
|---|---|---|
| cone <=> voice coil | 18 kg | 11 kg |
| cone <=> edge | 4.5 kg | 2.5 kg |
| input power durability | 120 W | 70 W |
| (breakage mode) | damage to voice coil | peeling of bonding |

It is apparent from Table 2 that the loudspeaker diaphragm of the exemplary embodiment which uses plasma treatment has better bonding strength than the conventional loudspeaker diaphragm using corona discharge.

In the input power durability test, the bonded area has peeled off in the conventional loudspeaker using corona discharge by input of 70 W. In the exemplary embodiment using plasma processing, burning of the voice coil 18 occurred by input of 120 W. However, no peeling of the bonded area has occurred, demonstrating extremely high bonding strength.

As for the reactive gas A, approximately the same results as for oxygen were obtained by the use of nitrogen gas or air. As for the material of the loudspeaker diaphragm 4, approximately the same effect was obtained with polypropylene or nylon resin.

As described above, the exemplary embodiment provides electrodes 5 outside the reactive chamber 1 for plasma treatment. This enables the suppression of temperature rise in the reactive chamber 1 and prevents heat deformation of the loudspeaker diaphragm 4. In addition, plasma can be uniformly applied by placing the loudspeaker diaphragm 4 in a meshed metal frame, resulting in improved productivity.

### Industrial Applicability

The method for manufacturing a loudspeaker diaphragm of the present invention disposes a resin loudspeaker diaphragm made by injection molding or sheet forming by heating in the reactive chamber, and provides electrodes outside the reactive chamber. This enables the temperature inside the reactive chamber to be kept below the heat deformation temperature of the loudspeaker diaphragm during surface activation of the loudspeaker diaphragm by application of plasma. The temperature inside the reactive chamber is kept below the heat deformation temperature of the loudspeaker diaphragm to prevent heat deformation of the loudspeaker diaphragm and to suppress the occurrence of defects caused by heat deformation.

In addition, more than one loudspeaker diaphragm is disposed inside the meshed metal frame in the reactive chamber at a predetermined interval to apply plasma almost uniformly. The gas disperses almost uniformly inside the reactive chamber through the meshed metal frame so that the surface is almost uniformly activated, assuring high wettability and stable high quality of the loudspeaker diaphragm.

Moreover, application of isocyanate primer after plasma treatment further improves the bonding strength and stabilizes the quality.

The material used for the loudspeaker diaphragm of the present invention is a monopolymer or copolymer of polyolefin resin such as polyethylene and polypropylene, or monopolymer or copolymer of polyamide resin. This enables a broad range of loudspeaker diaphragms with improved bonding strength and stable quality to be manufactured.

A loudspeaker manufactured using the loudspeaker diaphragm manufactured as above thus has uniform and improved bonding strength between the loudspeaker diaphragm and edge and/or voice coils, offering loudspeakers with improved input power durability.

What is claimed is:

1. A method for manufacturing a speaker diaphragm, said method comprising the steps of:
disposing a resin speaker diaphragm made by one of injection molding and sheet forming by heating in a reactive chamber;
disposing an electrode outside said reactive chamber; and
activating the surface of said speaker diaphragm by applying plasma while keeping the temperature inside said reactive chamber below the heat deformation temperature of said speaker diaphragm.

2. The method for manufacturing a speaker diaphragm as defined in claim 1, wherein a plurality of said resin speaker diaphragms are placed inside a in said reactive chamber at a certain interval so as to apply plasma substantially uniformly.

3. The method for manufacturing a speaker diaphragm as defined in claim 1, wherein isocyanate primer is applied after plasma treatment.

4. The method for manufacturing a speaker diaphragm as defined in claim 2, wherein isocyanate primer is applied after plasma treatment.

5. The method for manufacturing a speaker diaphragm as defined in claim 1, wherein one of monopolymer and copolymer of polyolefin such as polyethylene and polypropylene is used as a material for said speaker diaphragm.

6. The method for manufacturing a speaker diaphragm as defined in claim 2, wherein one of monopolymer and copolymer of polyolefin such as polyethylene and polypropylene is used as a material for said speaker diaphragm.

7. The method for manufacturing a speaker diaphragm as defined in claim 3, wherein one of monopolymer and copolymer of polyolefin such as polyethylene and polypropylene is used as a material for said speaker diaphragm.

8. The method for manufacturing a speaker diaphragm as defined in claim 4, wherein one of monopolymer and copolymer of polyolefin such as polyethylene and polypropylene is used as a material for said speaker diaphragm.

9. A speaker diaphragm manufactured in accordance with the steps of:
disposing a resin speaker diaphragm made by one of injection molding and sheet forming by heating in a reactive chamber;
disposing an electrode outside said reactive chamber; and
activating the surface of said speaker diaphragm by applying plasma while keeping the temperature inside said reactive chamber below the heat deformation temperature of said speaker diaphragm.

10. The speaker diaphragm as defined in claim 9, wherein isocyanate primer is applied after plasma treatment.

11. The speaker diaphragm as defined in claim 9, wherein one of monopolymer and copolymer of polyolefin such as polyethylene and polypropylene is used as a material for said speaker diaphragm.

12. The speaker diaphragm as defined in claim 10, wherein one of monopolymer and copolymer of polyolefin such as polyethylene and polypropylene is used as a material for said speaker diaphragm.

13. A speaker at least comprising:
a magnetic circuit;
a frame connected to said magnetic circuit; and
a speaker diaphragm whose inner circumference being connected to a voice coil embedded in a magnetic gap of said magnetic circuit, and outer circumference being bonded to said frame;
wherein said speaker diaphragm is one of that defined in claims 9 to 12.

14. A speaker at least comprising:
a magnetic circuit;
a frame connected to said magnetic circuit; and
a speaker diaphragm whose inner circumference being connected to a voice coil embedded in a magnetic gap of said magnetic circuit, and outer circumference being bonded to said frame via an edge;
wherein said speaker diaphragm is one of that defined in claims 9 to 12.
